(19) United States
(12) Patent Application Publication
(10) Pub. No.: US 2006/0200835 A1
(43) Pub. Date: Sep. 7, 2006

(54) Disk recorder and player

(75) Inventor: Kazuhiro Watanabe, Echizen-city (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: ORION ELECTRIC CO., LTD., Echizen-city (JP)

(21) Appl. No.: 11/362,221

(22) Filed: Feb. 27, 2006

(30) Foreign Application Priority Data
Mar. 1, 2005 (JP) 2005-055801

(51) Int. Cl. G11B 17/04

(52) U.S. Cl. 720/603

(57) ABSTRACT

The invention provides a disk recorder and player having a disk loading tray capable of mounting both large-diameter and small-diameter disks, wherein especially the small-diameter disk mounted on the disk loading tray is prevented from popping out and slipping into the disk recorder and player. A disk stopper projection composed of a notch portion, a supporting portion and a bent portion is formed near a large-diameter inner wall of the disk loading tray. Thereby, when a small-diameter disk mounted on a predetermined position on the disk loading tray is displaced, the disk stopper projections prevent the disk from falling, so as to prevent malfunction of the disk recorder and player caused by the small-diameter disk falling into the recorder and player.

The present application is based on and claims priority of Japanese patent application No. 2005-055801 filed on Mar. 1, 2005, the entire contents of which are hereby incorporated by reference.

### BACKGROUND OF THE INVENTION

1. Field of the Invention

The present invention relates to a disk recorder and player for recording and playing data on a disk-type recording medium (hereinafter simply referred to as disk), and more specifically, relates to a disk recorder and player capable of preventing a disk, especially a small-diameter disk, from popping out and falling from the predetermined mounting position on a disk loading tray during loading and ejecting of the disk loading tray and the like.

2. Description of the Related Art

One drawback of a disk recorder and player is that when a disk loaded on a tray for recording or playing data is released and discharged to the exterior of the device, the disk may pop out or fall from the tray into the device and could not be taken out or the tray being loaded in that state may be stuck in the device by the fallen disk, by which the manipulation of the recorder and player becomes impossible. There are demands for solutions to this problem, which are especially strong regarding devices for recording and playing data on two types of disks, a large-diameter disk and a small-diameter disk, especially regarding the arrangement for recording and playing data on a small-diameter disk.

Japanese Patent Application Laid-Open Publications No. 9-161368(patent document 1) and No. 7-326177 (patent document 2) disclose known prior arts for solving this problem.

Patent document 1 discloses a prior art disk recorder and player in which one or more engagement pawls are formed at the periphery of the large-diameter disk on the tray, the engagement pawls being elastically expanded in the direction toward the center of the loading tray.

Patent document 2 discloses a prior art disk recorder and player having a cover holding part formed at the periphery of the loading portion of the tray, and a disk support cover removably attached to the cover holding part so as to partially cover the disk mounted on the tray.

However, according to the arrangement of patent document 1, the disk mounted on the tray is clamped by some means by which the disk is prevented from falling, and the structure for mounting the disk on the tray does not have any means that prevent the disk from popping out or falling from the tray. In other words, the arrangement disclosed in patent document 1 has engagement pawls for preventing the disk from falling that are elastically expanded in the direction toward the center of the tray for clamping the disk to position, and it does not include any clamping means for supporting a small-diameter disk.

According to the arrangement disclosed in patent document 2, the disk support cover supports and prevents the disk from falling, which is an effective mechanism for preventing the disk from falling in a disk recorder and player having a vertically disposed tray. However, the arrangement is not intended to prevent the disk simply mounted on a tray from falling into the interior of the disk recorder and player in which the tray is disposed horizontally. Further, the arrangement requires the separate support cover and the mounting part thereof to be assembled additionally.

### SUMMARY OF THE INVENTION

The disk recorder and player according to the present invention is aimed at solving the prior art problems by providing a disk recorder and player capable of preventing the disk (especially the small-diameter disk) mounted on the disk loading tray from falling from the tray.

A first aspect of the present invention relates to a disk recorder and player capable of loading two types of disks, a large-diameter disk and a small-diameter disk, for recording and playing data on the disk, including a disk loading tray comprising a large-diameter disk housing recess for mounting the large-diameter disk, the large-diameter disk housing recess composed of a large-diameter disk loading surface which is one level lower than a tray reference plane which is an upper surface of the disk loading tray and a circular large-diameter inner wall rising from the large-diameter disk loading surface and having a diameter somewhat larger than the diameter of the large-diameter disk; a small-diameter disk housing recess formed in the inner side of and one level lower than the large-diameter disk housing recess; an opening formed to the disk loading tray for enabling an optical pickup for outputting a laser beam to the small-diameter disk or the large-diameter disk mounted on the disk loading tray to oppose to the disk; and a pair of disk stopper projections formed adjacent to the large-diameter disk housing recess for preventing the large-diameter disk and the small-diameter disk from falling.

According to the first aspect of the invention, since a pair of disk stopper projections is provided adjacent to the large-diameter disk housing recess for preventing the large-diameter disk and the small-diameter disk from falling, when the clamping is released during recording or playing of the disk or when the disk is loaded or ejected, the small-diameter disk or the large-diameter disk mounted on the disk loading tray can be supported by the disk stopper projections and prevented from falling into the disk recorder and player.

A second aspect of the present invention relates to the disk recorder and player according to the first aspect, wherein each disk stopper projection is formed in the shape of an inverted L composed of a supporting portion rising up from the reference plane of the tray and a bent portion connected to the end of the supporting portion.

According to the second aspect of the invention, the disk stopper projection has an inverted L-shaped form, so that when the mounted disk tilts and slides off from position, the disk is stopped by the supporting portion and supported by the bent portion connected to the end of the supporting portion that enwrap a portion of the disk.

A third aspect of the present invention relates to the disk recorder and player according to aspects 1 or 2, wherein an angle θ formed between two straight lines connecting two engagement points of the small-diameter disk engaged with the pair of disk stopper projections and a center point of the small-diameter disk is equal to or smaller than 120 degrees and equal to or greater than 80 degrees.

According to the third aspect of the present invention, the angle θ is determined appropriately before determining the distance between the pair of disk stopper projections, so that the projections are placed at widths preferable for supporting the disks, and the small-diameter disk can be supported more securely.

### BRIEF DESCRIPTION OF THE DRAWINGS

FIG. 1 is a perspective view showing a disk recorder and player according to one embodiment of the present invention;

FIG. 2 is a perspective view showing a disk loading tray according to the same;

FIG. 3 is a cross-sectional view showing the state in which the disk loading tray is viewed from the side according to the same;

FIG. 4 is a plan view showing the disk loading tray according to the same;

FIG. 5 is a plan view of the disk loading tray showing the state in which the small-diameter disk is supported by the disk stopper projections according to the same;

FIG. 6 is an explanatory view showing another embodiment in which no notch portion is formed to the disk loading tray; and

FIG. 7 is a cross-sectional view showing the state in which the disk loading tray of FIG. 6 is viewed from the side.

### DETAILED DESCRIPTION OF THE PREFERRED EMBODIMENTS

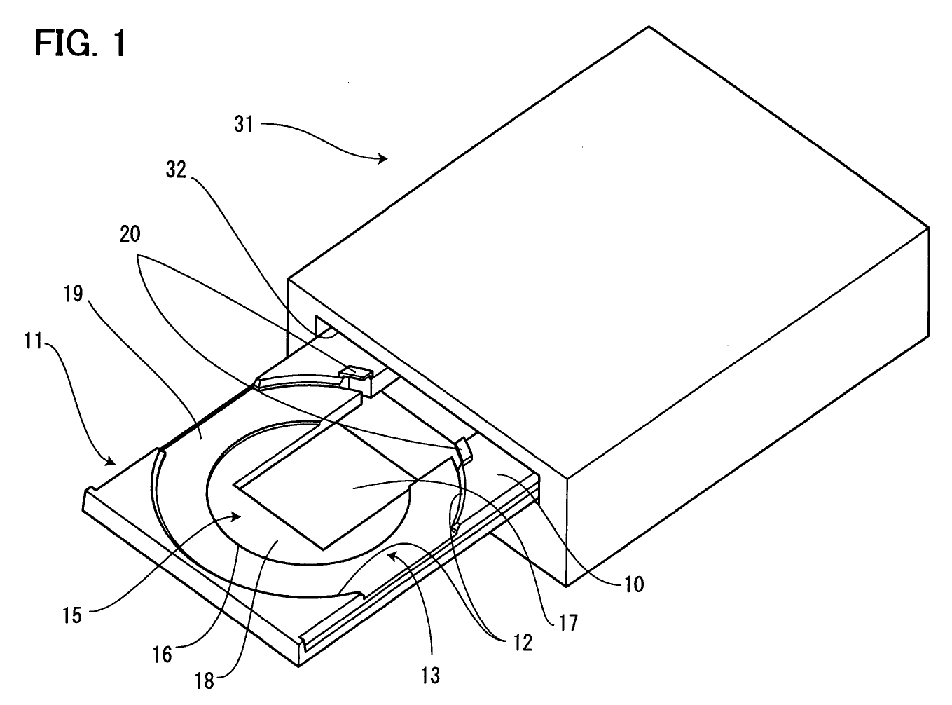

Now, the preferred embodiments for carrying out the present invention will be describe with reference to FIGS. 1 through 7. Needless to say, the present invention is not limited to the preferred embodiments disclosed hereafter, but covers a range within the scope of the present invention applicable by those skilled in the art other than the arrangements disclosed in the preferred embodiments.

FIG. 1 is a perspective view showing the disk recorder and player according to the present invention. As shown in the drawing, a disk recorder and player 31 can be used as an independent device or as a component assembled with other devices to constitute a composite device.

The disk recorder and player 31 has a rectangular body, having an inserting slot 32 formed on one face thereof, and a disk loading tray 11 for mounting a disk is arranged to move in and out through the inserting slot 32 driven by a loading mechanism (not shown) disposed inside the disk recorder and player 31. The term “recording and playing” refers to recording and/or playing.

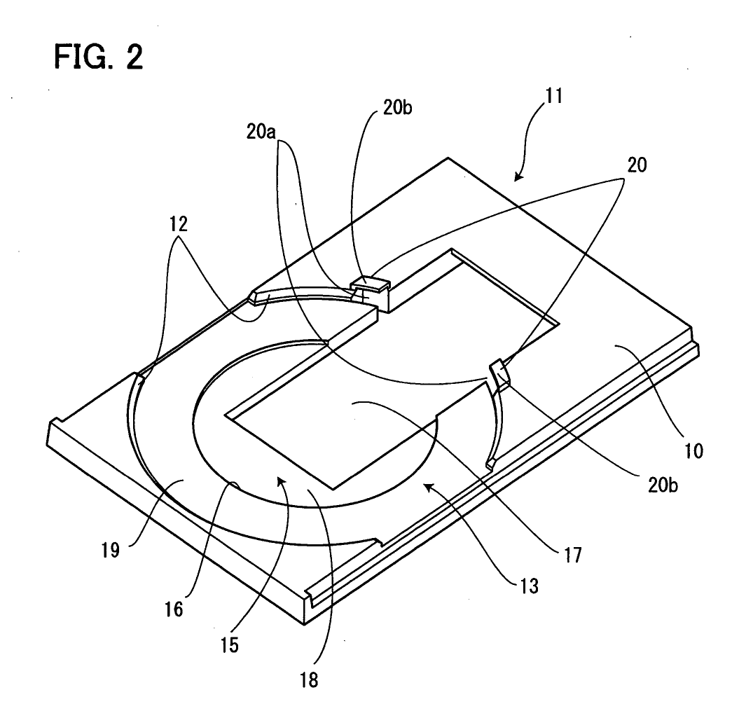

Next, the structure of the disk loading tray which is the characteristic portion of the present invention will be described with reference to FIGS. 2 through 7. The disk recorder and player 31 according to the present invention is a device capable of recording and/or playing data on two types of disks, a large-diameter disk (diameter: 12 cm) and a small-diameter disk (diameter: 8 cm), and a loading surface of the disk loading tray 11 manufactured by injection-molding a resin material is formed to have a large-diameter disk housing recess 13 for mounting a disk. The large-diameter disk housing recess 13 is formed one level lower than a tray reference plane 10 which is the upper surface of the disk loading tray 11 for mounting the large-diameter disk, and the large-diameter disk housing recess 13 is defined by a large-diameter disk loading surface 19 formed one level lower than the upper surface and a circular large-diameter inner wall 12 rising up from the large-diameter disk mounting surface 19 and having a diameter somewhat larger than the diameter of the large-diameter disk.

On the inner side of the large-diameter disk housing recess 13 is formed a small-diameter disk housing recess 15 which is one level lower than recess 13, and the small-diameter disk housing recess 15 is defined by a small-diameter disk loading surface 18 for mounting the small-diameter disk 50 and a small-diameter inner wall 16 rising up from the small-diameter disk loading surface 18 and having a diameter some what smaller than that of the small-diameter disk.

At the center of the large-diameter disk loading surface 19 for loading the large-diameter disk and the small-diameter disk loading surface 18 for loading the small-diameter disk is disposed an optical pickup for radiating a laser beam to the lower surface of the small-diameter disk or the large-diameter disk mounted on the disk loading tray 11, and an opening 17 is formed to the disk loading tray 11 in order to have the optical pickup face the lower surface of the loaded disk.

Moreover, the disk loading tray 11 has disk stopper projections 20 positioned at the rear portion of the large-diameter disk housing recess 13 (when the front side is defined as the inserting slot-side of the disk loading tray 11) near the large-diameter inner wall 12 for preventing the small-diameter disk and large-diameter disk from falling. One pair of disk stopper projections 20 is formed near the edge of the opening 17 to engage and hold the disk from popping out.

We will now describe the disk stopper projection 20 for preventing the disk from popping out. The disk stopper projection 20 should preferably have an inverted L-shaped cross-section and be formed near the large-diameter inner wall 12 at the rear portion of the disk loading tray 11. With consideration on the removal process of a mold used for forming the projection, the disk stopper projection 20 having an inverted L-shaped cross-section is formed to this position by forming a notch portion 20a having a predetermined length on the large-diameter inner wall 12 of the large-diameter disk housing recess 13, a supporting portion 20c rising to a position higher than the tray reference plane 10 above the notch portion 20a, and a bent portion 20b connected to the upper end of the supporting portion 20c. The upper portion of height H of the supporting portion 20c rising above the tray reference plane 10 is lower than the inserting slot 32 of the disk loading tray 11, so as not to interfere with the disk loading tray 11 moving in and out through the slot by the loading mechanism.

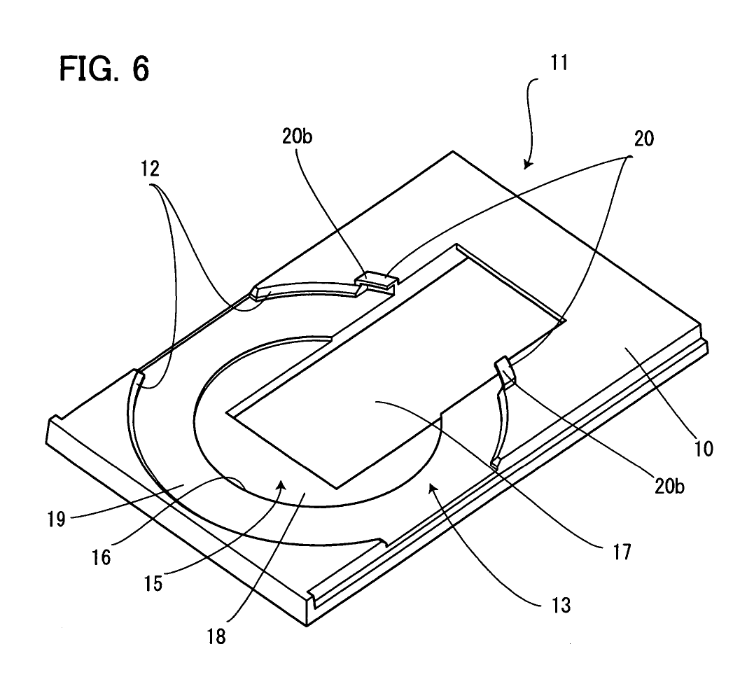

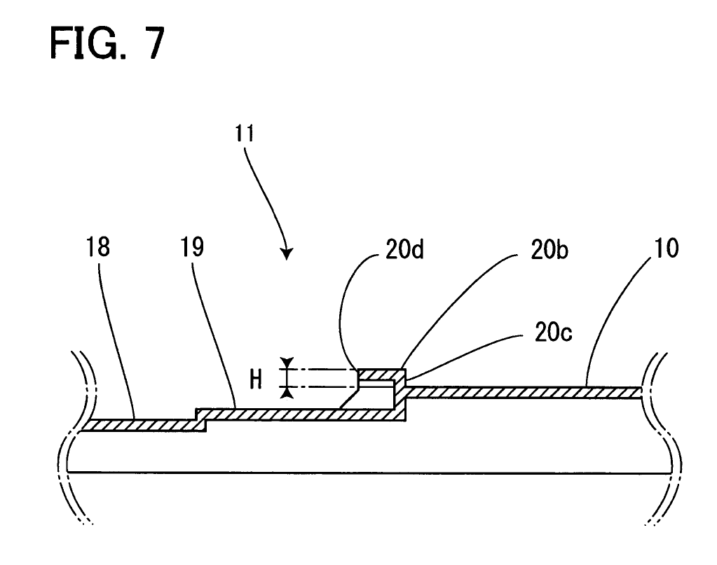

According to the present embodiment, the end 20d of the disk stopper projection 20 is formed outward than the large-diameter disk housing recess 13, but it is also possible not to provide a notch portion 20a on the large-diameter inner wall 12, as illustrated in FIGS. 6 and 7.

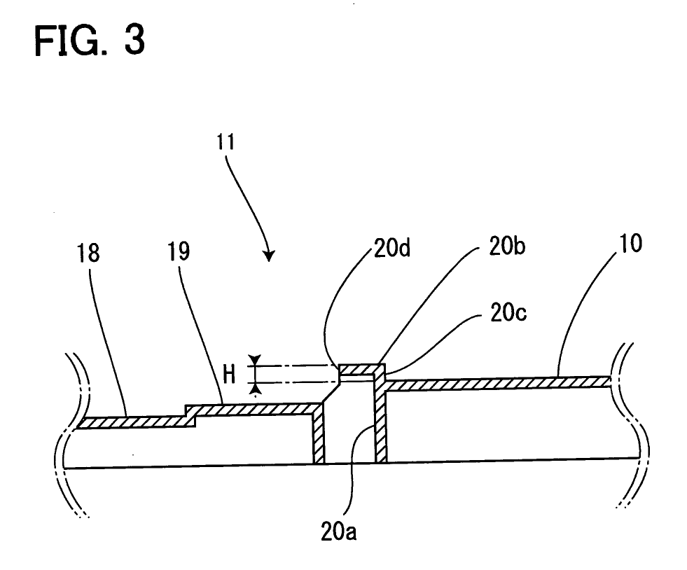

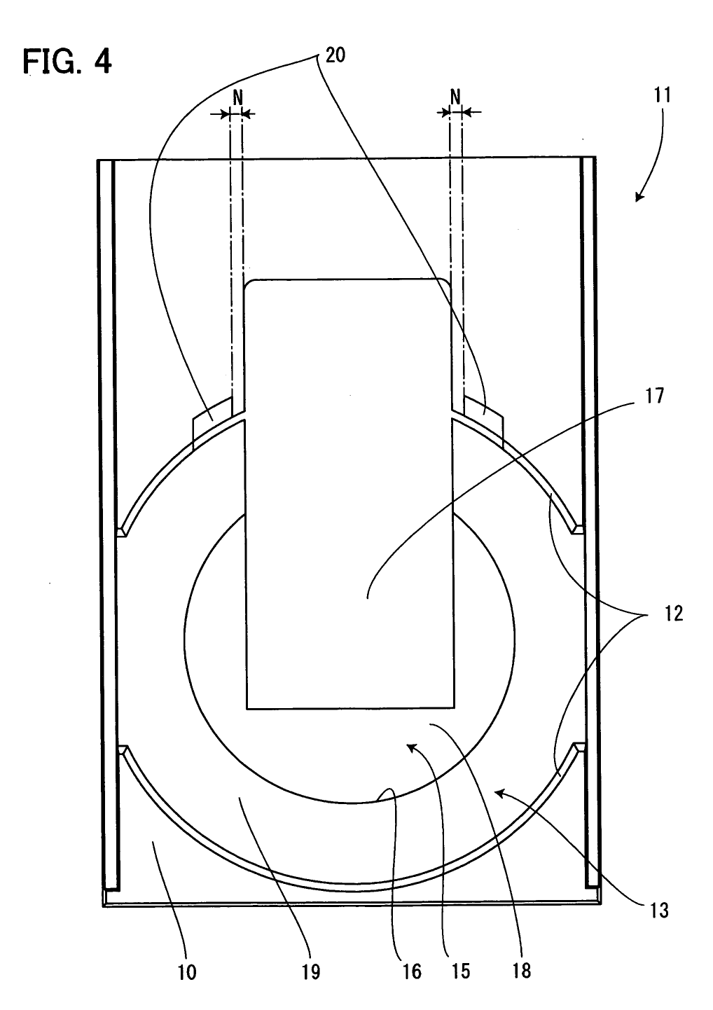

Regarding the position for forming the disk stopper projection 20, it is most preferable to form the pair of disk stopper projections 20 near the large-diameter inner wall 12 of the large-diameter disk housing recess 13 and adjacent to the edge of the opening 17 formed to the disk loading tray 11, as shown in FIGS. 2 and 3. However, it is not inevitable that the disk stopper projections 20 are formed adjacent to the edge of the opening 17. In some cases, as shown in FIG. 4, the disk stopper projections 20 can be formed away from the edge of the opening 17 by a given distance N, and in that case, the given distance N is small enough to form a connected notch portion 20a in the large-diameter inner wall 12 from the edge of the opening 17. Needless to say, the notch portion 20a is not necessarily connected to the edge of the opening 17, but it can be formed within the area corresponding only to the width of each disk stopper projection 20. Though the latter design is difficult to form via molding, it is more preferable from the viewpoint of strength of the disk loading tray 11. Moreover, the given distance N of the disk stopper projection 20 from the edge of the opening 17 can be determined at will, but the distance between the pair of disk stopper projections 20 must be smaller than the diameter (8 cm) of the small-diameter disk.

However, if the notch portions 20a are formed to be connected from the edge of the opening 17, the given distance N shown in FIG. 4 should be appropriately determined since the length of given distance N between the disk stopper projection 20 and the edge of the opening 17 is inversely proportional to the strength of the disk loading tray 11, and in the present embodiment, the distance N is actually about 3 mm. In the embodiment, the width of the opening 17 is 50 mm.

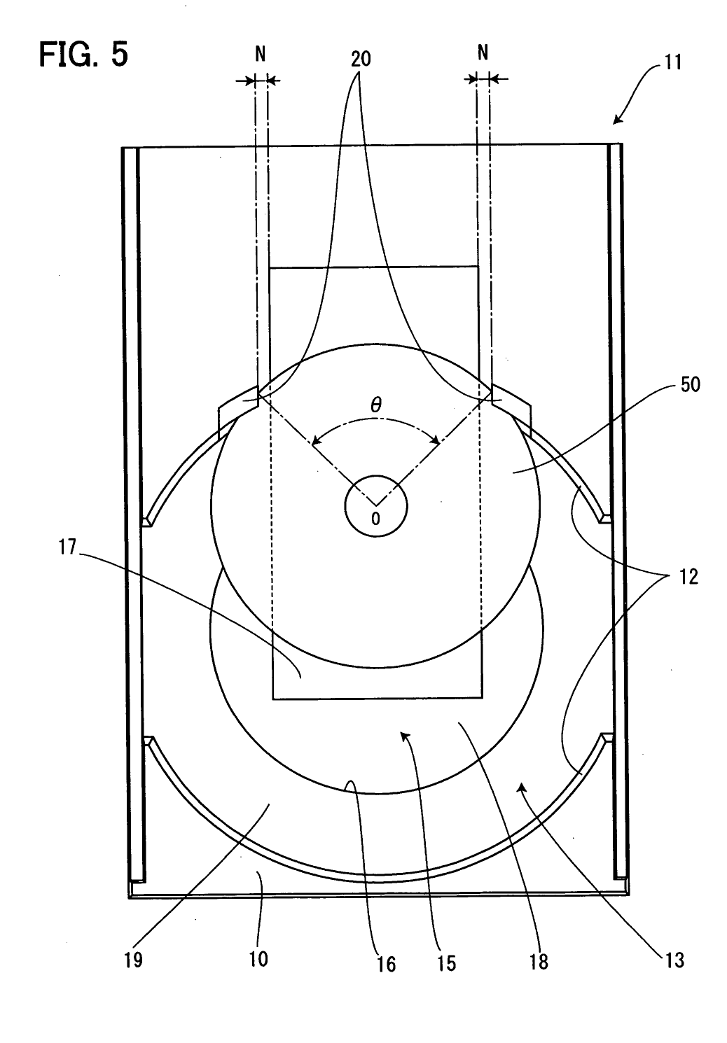

Further, as shown in FIG. 5, an angle θformed between the two engagement points of the small-diameter disk 50 engaged with the pair of disk stopper projections 20 and the two straight lines connecting the center point O of the small-diameter disk 50 is proportional to the given distance N of the disk stopper projection 20 from the edge of the opening 17. Here, angle θshould be smaller than 180 degrees in order to engage the small-diameter disk 50, and practically, the angle should be equal to or smaller than 120 degrees. According to the embodiment illustrated in FIG. 5 showing the most preferable example, in consideration of the strength of the disk loading tray 11, the given distance N of the disk stopper projection 20 from the edge of the opening 17 is approximately 3mm (provided that the width of the opening is approximately 50 mm), and as a result, the angle θis approximately 90 degrees.

Next, the operation of the disk recorder and player 31 having the above-described arrangement will be described. According to a prior-art disk recorder and player without disk stopper projections 20, when a disk is mounted on the disk housing recess of the disk loading tray 11 and the disk loading tray 11 is loaded into the disk recorder and player body, the disk may pop out and fall from the disk loading tray when the tray is moved in and out of the body due to inappropriate mounting of the disk or cancellation of the disk playing operation by the user or the like, which may lead to damage of the disk, deterioration of the interior of the device or malfunction of the device. Serious problems tend to occur when loading and ejecting small-diameter disks 50 compared to loading and ejecting large-diameter disks. FIG. 5 illustrates a state in which the small-diameter disk 50 is prevented from falling from the disk loading tray 11 and sliding into the disk recorder and player 31 by being displaced or popping out from its predetermined position on the small-diameter disk loading surface 18 of the disk loading tray 11. As illustrated in FIG. 5, the small-diameter disk 50 is engaged with and stopped by the inverted L-shaped disk stopper projections 20 composed of a bent portion 20b and a supporting portion 20c, by which the small-diameter disk 50 is prevented from falling into the disk recorder and player 31. Needless to say, according to the above arrangement, the large-diameter disk mounted on the large-diameter disk loading surface 19 can be prevented from falling into the disk recorder and player 31 in the same manner.

The present invention having the arrangement disclosed above enables to prevent not only the large-diameter disk but also the small-diameter disk which tends to slide out of position from falling into the disk recorder and player 31, even if the disk is displaced from its predetermined mounting position on the disk loading tray 11. As a result, the present invention enables to prevent malfunction of the disk recorder and player 31 due to the displacement of the disk, and also to prevent the disk from interfering with the loading and ejecting movement of the disk loading tray 11.

Moreover, since the disk stopper projections 20 can be formed integrally with the disk loading tray 11, the present disk loading tray 11 can be manufactured at a low cost without having to manufacture additional members. Furthermore, since it is possible to replace the prior art disk loading tray with the disk loading tray 11 of the present invention, the prior art disk recorder and player can achieve the same effects of the present invention by replacing the disk loading tray with the disk loading tray 11 of the present invention.

The present invention further characterizes in that the angle θ formed between the two straight lines connecting the center θ of the small-diameter disk 50 and the two engagement points of the small-diameter disk 50 engaged with and supported by the pair of disk stopper projections 20 is smaller than 180 degrees, and preferably equal to or smaller than 120 degrees and equal to or greater than 80 degrees, more preferably greater than 90 degrees. Since the angle θis set to a preferable angle before the distance between the pair of disk stopper projections 20 is determined, the distance becomes preferable to engage the disk, so the small-diameter disk 50 can be engaged more securely. Accordingly, it becomes possible to prevent the small-diameter disk 50 and the large-diameter disk from falling into the disk recorder and player 31.

The present invention is not limited to the embodiments illustrated here, and the same effects can be achieved by other arrangements with the same functions.

The effects of the present invention are as follows.

The first aspect of the present invention provides a disk recorder and player capable of loading two types of disks, a large-diameter disk and a small-diameter disk, for recording and playing data on the disk, including a disk loading tray comprising a large-diameter disk housing recess for mounting the large-diameter disk, the large-diameter disk housing recess composed of a large-diameter disk loading surface which is one level lower than a tray reference plane which is an upper surface of the disk loading tray and a circular large-diameter inner wall rising from the large-diameter disk loading surface and having a diameter somewhat larger than the diameter of the large-diameter disk, a small-diameter disk housing recess formed in the inner side of and one level lower than the large-diameter disk housing recess, an opening formed to the disk loading tray for enabling an optical pickup for outputting a laser beam to the small-diameter disk or the large-diameter disk mounted on the disk loading tray to oppose to the disk, and a pair of disk stopper projections formed adjacent to the large-diameter disk housing recess for preventing the large-diameter disk and the small-diameter disk from falling. Therefore, even if the clamped disk is released during the recording or playing operation, or if the disk pops out from the tray during loading or ejecting of the disk, the disk stopper projections receive the disk and prevent the disk from falling into the disk recorder and player, and as a result, prevent the disk recorder and player from being damaged.

The second aspect of the present invention provides a disk recorder and player according to aspect 1, wherein each disk stopper projection is formed in the shape of an inverted L composed of a supporting portion rising up from the reference plane of the tray and a bent portion connected to the end of the supporting portion. Therefore, the disk stopper projections can receive the disk by enwrapping a portion of the disk to thereby prevent the disk from falling from the disk loading tray and falling into the disk recorder and player.

The third aspect of the present invention provides a disk recorder and player according to aspects 1 or 2, wherein an angle θformed between two straight lines connecting two engagement points of the small-diameter disk engaged with the pair of disk stopper projections and a center point of the small-diameter disk is equal to or smaller than 120 degrees and equal to or greater than 80 degrees. According to this arrangement, the disk stopper projections can support the small-diameter disk securely and prevent the disk from falling into the disk recorder and player and damaging the recorder and player.

What is claimed is:

1. A disk recorder and player capable of loading two types of disks, a large-diameter disk and a small-diameter disk, for recording and playing data on the disk, including a disk loading tray comprising:
a large-diameter disk housing recess for mounting the large-diameter disk, the large-diameter disk housing recess composed of a large-diameter disk loading surface which is one level lower than a tray reference plane which is an upper surface of the disk loading tray and a circular large-diameter inner wall rising from the large-diameter disk loading surface and having a diameter somewhat larger than the diameter of the large-diameter disk;
a small-diameter disk housing recess formed in the inner side of and one level lower than the large-diameter disk housing recess;
an opening formed to the disk loading tray for enabling an optical pickup for outputting a laser beam to the small-diameter disk or the large-diameter disk mounted on the disk loading tray to oppose to the disk; and
a pair of disk stopper projections formed adjacent to the large-diameter disk housing recess for preventing the large-diameter disk and the small-diameter disk from falling.

2. The disk recorder and player according to claim 1, wherein each disk stopper projection is formed in the shape of an inverted L composed of a supporting portion rising up from the reference plane of the tray and a bent portion connected to the end of the supporting portion.

3. The disk recorder and player according to claim 1, wherein an angle θ formed between two straight lines connecting two engagement points of the small-diameter disk engaged with the pair of disk stopper projections and a center point of the small-diameter disk is equal to or smaller than 120 degrees and equal to or greater than 80 degrees.

4. The disk recorder and player according to claim 2, wherein the angle θformed between two straight lines connecting two engagement points of the small-diameter disk engaged with the pair of disk stopper projections and the center point of the small-diameter disk is equal to or smaller than 120 degrees and equal to or greater than 80 degrees.
